(19) United States
(12) Patent Application Publication
(10) Pub. No.: US 2010/0107963 A1
(43) Pub. Date: May 6, 2010

(54) Marking stake and carrier

(76) Inventor: Charles E. Black, Lexington, KY (US)

Correspondence Address: KING & SCHICKLI, PLLC, 247 NORTH BROADWAY, LEXINGTON, KY, 40507, US

(21) Appl. No.: 12/290,421

(22) Filed: Oct. 30, 2008

(51) Int. Cl. G01D 21/00

(52) U.S. Cl. 116/209

(57) ABSTRACT

Apparatus and methods are described for marking stakes and carriers. Marking stakes have a body and tab. The body's proximal end and the tab can be tilted out of a plane containing the remainder of the body so that apertures on the body and the tab register with one another and the body is tensioned substantially upright. The body's length is sufficient so that when the proximal end is fastened to a mounting surface the distal end is visible. The body may be flexible, avoiding dislodged, broken, bent, or moved stakes and preserving lines, curves, grades, offsets, cuts, and fills. The stake can remain flat when not in use, overcoming the problem of handling and transporting bulky stakes. Marking stake carriers carry lengthy stakes and fasteners and fasten to surveying rods with various diameters, providing a simple and organized method to handle and transport marking equipment.

### FIELD OF THE INVENTION

Generally, the present invention relates to marking stakes and marking stake carriers. Particularly, it relates to stakes and carriers which may be used for establishing lines, curves, grades, offsets, cuts, fills, or the like during marking, surveying, engineering, or other tasks.

### BACKGROUND OF THE INVENTION

Marking stakes are often used on construction sites to represent lines, curves, grades, offsets, cuts, and fills. However, such marking stakes are often too short to be visible to users, for example, in fields overgrown with grass or weeds. In addition, marking stakes are typically constructed of wood, plastic, or metal and are often rigid. Accordingly, the stakes are often susceptible to being dislodged from the ground, broken, bent, and moved in such a way as to destroy the lines, curves, grades, offsets, cuts, and fills that they represent. The dislodging and destruction of the stakes from their established positions often becomes a major problem when heavy construction vehicles are in operation in and around the vicinity in which the stakes are in use. Also, many marking stakes may only be driven into limited types of mounting surfaces.

Further, marking stakes are often bulky and heavy, making it difficult for marking teams to handle and transport the stakes about a marking site, such as a surveying site. This latter problem is intensified where the stakes are used on difficult terrain where the stakes must be carried to the marking site on foot. Moreover, there is not a simple method for marking teams to handle and transport the stakes and other marking equipment, such as stake fasteners. In addition, aligning and driving marking stakes is often a tedious and slow process.

Additionally, colored ribbons are often used with marking stakes to indicate different uses. For example, blue ribbons may be used to mark water lines in a survey area and orange ribbons may be used to mark electrical lines in the same survey area. However, the colored ribbons are often difficult to see and may become detached from the marking stakes, destroying a user's ability to differentiate between the different markings, such as different lines.

Therefore, there is a need in the art for a marking stake that is lengthy enough to be visible to a user. In addition, there is a need for a marking stake that is not susceptible to being dislodged from the ground, broken, bent, or moved in such a way as to destroy the lines, curves, grades, offsets, cuts, and fills that it represents. Further, there is a need for a marking stake that may be driven into almost any type of mounting surface. There is also a need for a marking stake that is not bulky and heavy when handled and transported about a marking site. The need further contemplates a simple method for marking teams to handle and transport the stakes and other marking equipment. The need also contemplates a relatively simple and quick method to align and drive a marking stake. In addition, the need contemplates a highly visible method for indicating different markings. Naturally, any improvements along such lines should further contemplate good engineering practices, such as relative inexpensiveness, stability, flexibility, ease of manufacturing, etc.

### SUMMARY OF THE INVENTION

The foregoing and other problems become solved by applying the principles and teachings associated with the hereinafter-described methods and apparatus for marking stakes and marking stake carriers.

In a representative embodiment, the marking stake has a body and a tab. The body of the stake defines a plane and includes a proximal end, a distal end, an aperture near the proximal end, and a length, which may vary. The tab also includes an aperture. The tab may be formed by any of a variety of methods. For example, the tab may be die cut from the body of the stake. Composition materials for the stake include, but are not limited to, Correx®, rigid polymers, wood, cardboard, composite materials, and the like.

The stake may be any of a variety of colors, including, but not limited to, red, blue, green, yellow, orange, purple, and the like. Also, the stake may be substantially a uniform color or may include a variety of colors, and the stake may be partially or entirely colored. Further, differently colored marking stakes may correspond to different uses, eliminating the need for colored ribbons to indicate different uses. For example, blue marking stakes may be used to mark water lines in a survey area and orange marking stakes may be used to mark electrical lines in the same survey area. In this respect, different markings may be made in the same area without using colored ribbons. In addition, the differently colored stakes are more visible than colored ribbons, which are often difficult to see and may become detached from the marking stakes.

During use, the body of the stake is folded to tilt the proximal end and the tab out of the plane containing the remainder of the body. In turn, a user registers with one another the apertures on the body and the tab, and a fastener is driven through the apertures and into a mounting surface. Accordingly, the body is tensioned in a substantially upright orientation so that users can see it from a distance. In other words, the tab acts as a guy-wire of sorts to support the stake in an upright position. In this manner, the stake may be aligned and driven into a variety of mounting surfaces relatively quickly and easily.

The fastener can take the form of any of a variety of devices, such as a magnetic nail, a gutter spike, a roofing nail, a tack, a wooden stake, or the like. In certain embodiments, the aperture in the tab may be formed prior to driving the fastener through the tab, and the aperture in the body may be formed prior to driving the fastener through the body. In other embodiments, the fastener may be used to create the aperture in the tab and/or body. In still other embodiments, the tab and/or body may have a small hole or dimple, and the fastener may simply expand the small hole or dimple. That is, the tab and/or body may have a small hole with a diameter, and the fastener, having a diameter larger than that of the small hole, may be driven through the small hole to expand the diameter of the small hole.

In certain embodiments, the fastener may be used to create a hole in the mounting surface or may fill a hole during driving. For example, the force of a hammer driving a nail into a surface may create a hole, or a small hand drill can be used to pre-drill a hole into virtually any mounting surface, such as, solid rock, concrete, coal, pavement, a car hood, or the like.

The length of the stake body is sufficient so that when the proximal end is fastened to a mounting surface the distal end can be viewed by a user, for example, in a field overgrown with weeds and grass. Accordingly, the present invention addresses the need for a marking stake that is lengthy enough to be visible to a user. In addition, the body of the stake may be relatively flexible. In this manner, the body may fold, tilt, or the like, and the stake is not susceptible to being dislodged from the ground, broken, bent, or moved in such a way as to destroy the lines, curves, grades, offsets, cuts, and fills that it represents.

Other features of the stake contemplate graduations or the capability to receive writing, which may serve any of a variety of functions. For example, desired grade levels may be marked on graduations on the stake to indicate an amount of land fill or cut to be made at the point indicated by the stake. Also, features of the stake contemplate advertising on the stake.

Still other features contemplate an aperture, such as a circular hole, near the distal end of the body of the stake, and an indicator that may be extended through the aperture. The indicator may be any of a variety of devices, such as a piece of string, a cloth flag, a plastic ribbon, or the like. In this manner, a cloth flag or plastic ribbon may be placed through the aperture to make the stake highly visible at a great distance, or a string may be placed through the apertures in several stakes to further assist in visualizing a marked area, such as a floor plan or a sewer or water line.

Also, the stake may include a transverse tear line near the proximal end of the body, formed, for example, by a series of aligned perforations. The tear line permits a portion of the body near the distal end to be torn away, as when the stake is struck by a lawnmower blade or the treads or wheels of a vehicle, so that a remainder of the body near the proximal end, the tab, and the fastener, will not be dislodged from the mounting surface to cause a loss of the desired point as marked. In this manner, the present invention further overcomes the problem of marking stakes susceptible to being dislodged from the ground, broken, bent, or moved in such a way as to destroy the lines, curves, grades, offsets, cuts, and fills that they represent.

When the stake is not in use, it can remain flat, overcoming the prior art problems of handling and transporting bulky stakes. In this manner, a series of stakes may lie in flat, lightweight stacks and may be hand-carried readily in the field by a marking team.

In a representative embodiment, the marking stake carrier has a first portion, a second portion, and an adjustable fastener. The first portion is for carrying the marking stakes and has a volume and a length sufficient to accommodate carrying substantially a full length of the lengthy marking stakes. The second portion is for carrying the marking stake fasteners and has a volume substantially less than the volume of the first portion. The first and second portions may take the form of any of a variety of shapes, including, but not limited to, cylindrical, cubical, rectangular, oblong, and the like. Also, the adjustable fastener is capable of fastening to a surveying rod with various diameters and may take a variety of forms, such as Velcro® strips, adjustable buckles, buckles with adjustable straps, or the like. Composition materials for various portions of the carrier include, but are not limited to, nylon, cotton, polyester, textile blends, rigid polymers, flexible polymers, composite materials, and the like. Methods of attachment for various parts of the carrier include, but are not limited to, integral formation, sewing, gluing, stapling, and the like.

Altogether, the first portion, second portion, and adjustable fastener form an all-in-one carrier capable of simultaneously carrying the lengthy marking stakes and marking stake fasteners and of fastening to surveying rods with various diameters. As a result, the carrier addresses the need for a simple and organized method to handle and transport stakes and other marking equipment. Further, a series of stakes can be placed in the carrier, as the stakes are adapted to lie in flat, lightweight stacks. In this manner, the carrier and the stake of the present invention further address the need for a simple method to handle and transport stakes. Optionally, a third portion may be sized and shaped to carry a writing utensil. Various handles, shoulder straps, etc. may also be adorn the carrier to facilitate transporting the carrier and its contents.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1a is a front view in accordance with the teachings of the present invention showing a marking stake;

FIG. 1b is a partial front view in accordance with the teachings of the present invention showing a bottom portion of the marking stake of FIG. 1a;

FIG. 2a is an angled front view in accordance with the teachings of the present invention showing the bottom portion of the marking stake of FIG. 1a during use, with a tab slightly tilted;

FIG. 2b is a side view in accordance with the teachings of the present invention showing the marking stake of FIG. 1a, about to be fastened to a mounting surface;

FIG. 2c is a front view in accordance with the teachings of the present invention showing the marking stake of FIG. 1a, fastened to the mounting surface;

FIG. 2d is a side view in accordance with the teachings of the present invention showing the marking stake of FIG. 1a, fastened to the mounting surface;

FIG. 3 is an angled front view in accordance with the teachings of the present invention showing a marking stake carrier;

FIG. 4 is a front view in accordance with the teachings of the present invention showing a marking stake with graduations;

FIG. 5 is a front view in accordance with the teachings of the present invention showing a marking stake capable of receiving writing;

FIG. 6 is a front view in accordance with the teachings of the present invention showing a marking stake with advertising;

FIG. 7a is an angled front view in accordance with the teachings of the present invention showing a top portion of a marking stake with an aperture; and

FIG. 7b is an angled front view in accordance with the teachings of the present invention showing a bottom portion of a marking stake with a tear line.

### DETAILED DESCRIPTION OF THE ILLUSTRATED EMBODIMENTS

In the following detailed description of the preferred embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical and/or other changes may be made without departing from the scope of the present invention. The following detailed description is, therefore, not to be taken in a limiting sense. In accordance with the present invention, methods and apparatus are hereinafter described for marking stakes and carriers.

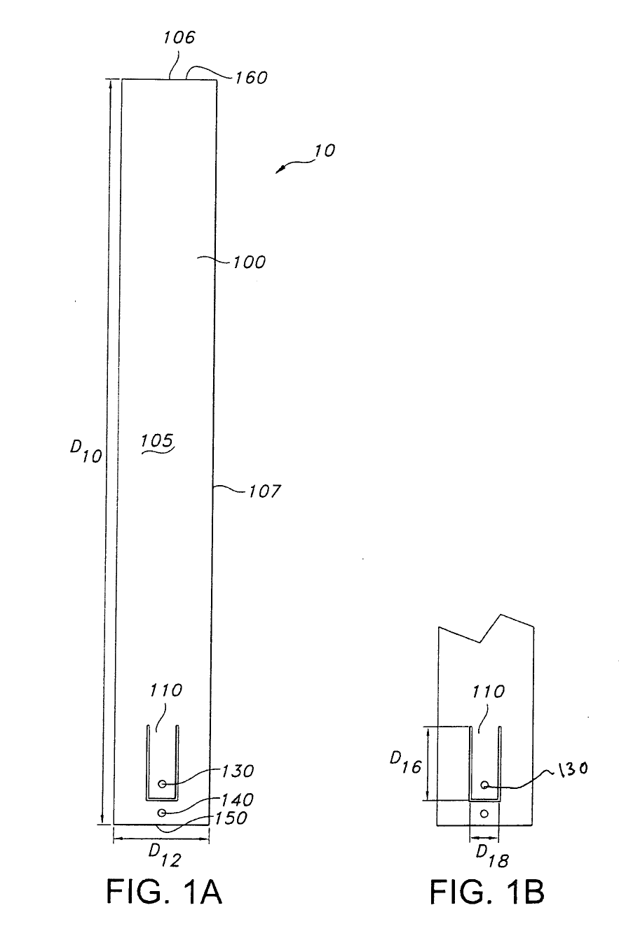

FIG. 1a illustrates a representative embodiment of a marking stake 10 of the present invention, including a body 100 and a tab 110. The body 100 defines a plane and includes a proximal end 150, a distal end 160, and an aperture 140 near the proximal end. In addition, the body 100 includes a length D₁₀, which may vary. The length D₁₀ is sufficient so that when the proximal end 150 is fastened to a mounting surface the distal end 160 can be viewed by a user. In certain embodiments, the length is sufficient so that when the proximal end is fastened to a mounting surface the distal end is visible even in an overgrown field with weeds and grass. Also, in certain embodiments, the length D₁₀ may be approximately 32 inches. Many other lengths are possible in other embodiments.

The body 100 may also include a width D₁₂, which may vary. In certain embodiments, the width D₁₂ may be approximately 1.5 inches. Many other widths are possible in other embodiments. Also, the body may be relatively flexible and may take the form of any of a variety of shapes, including, but not limited to, rectangular, square, oblong, and the like.

Turning to FIG. 1b, the tab 110 includes an aperture 130. The tab may be formed by any of a variety of methods. In certain embodiments, the tab may be die cut from the body of the stake. In other embodiments, the tab may integrally formed with the body portion. In still other embodiments, the tab may be attached to the body portion. Methods of attachment include, but are not limited to, gluing, stapling, nailing, and the like.

In addition, the tab 110 may include a length D₁₆ and a width D₁₈, which may vary. In certain embodiments, the length D₁₆ may be approximately 1.5 inches and the width D₁₈ may be approximately 0.5 inch. Many other lengths and widths are possible in other embodiments. Also, the tab may take the form of any of a variety of shapes, including, but not limited to, rectangular, square, oblong, and the like.

Composition materials for the stake 10 include, but are not limited to, Correx®, rigid polymers, wood, cardboard, composite materials, and the like. In certain embodiments, the body of the stake may be cut from commercial sheets of Correx® measuring 4 feet by 8 feet. In such embodiments, three rows of multiple stake bodies, each stake body having a length of 32 inches, may be easily cut from each sheet.

The stake 10 may be any of a variety of colors, including, but not limited to, red, blue, green, yellow, orange, purple, and the like. Also, the stake may be substantially a uniform color or may include a variety of colors, and the stake may be partially or entirely colored. Further, differently colored marking stakes may correspond to different uses, eliminating the need for colored ribbons to indicate different uses. For example, blue marking stakes may be used to mark water lines in a survey area and orange marking stakes may be used to mark electrical lines in the same survey area. In this respect, different markings may be made in the same area without using colored ribbons. In addition, the differently colored stakes are more visible than colored ribbons, which are often difficult to see and may become detached from the marking stakes.

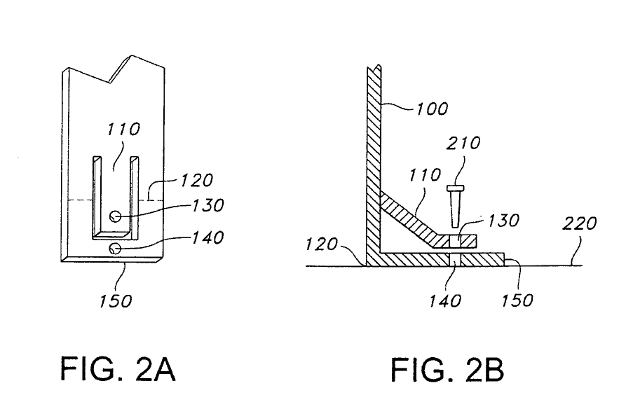

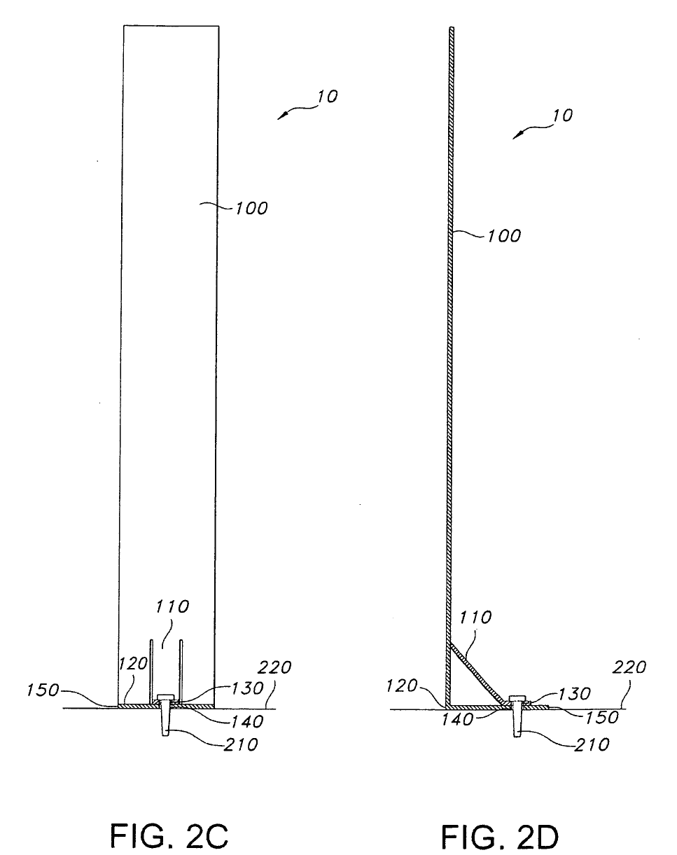

Turning to FIGS. 2a, 2b, 2c, and 2d, a representative use of the marking stake 10 is illustrated. During use, the body 100 is folded along a line 120 to tilt the proximal end 150 and the tab 110 out of the plane containing the remainder of the body. In turn, a user registers with one another the apertures 130 and 140, and a fastener 210 is driven through the apertures 130 and 140 and into a mounting surface 220. Accordingly, the body is tensioned in a substantially upright orientation so that users can see it from a distance. In other words, the tab acts as a guy-wire of sorts to support the stake in an upright position. In this manner, the stake may be aligned and driven into a variety of mounting surfaces relatively quickly and easily.

The fastener 210 can take the form of any of a variety of devices, such as a magnetic nail, a gutter spike, a roofing nail, a tack, a wooden stake, or the like. In certain embodiments, the aperture 130 may be formed prior to driving the fastener through the tab, and the aperture 140 may be formed prior to driving the fastener through the body. In other embodiments, the fastener may be used to create the aperture in the tab and/or body. In still other embodiments, the tab and/or body may have a small hole or dimple, and the fastener may simply expand the small hole or dimple. That is, the tab and/or body may have a small hole with a diameter, and the fastener, having a diameter larger than that of the small hole, may be driven through the small hole to expand the diameter of the small hole.

In addition, in certain embodiments, the fastener 210 may be used to create a hole in the mounting surface 220. In other embodiments, the fastener may fill a hole during driving. For example, the force of a hammer driving a nail into a surface may create a hole, or a small hand drill can be used to pre-drill a hole into virtually any mounting surface, such as, solid rock, concrete, coal, pavement, a car hood, or the like.

As mentioned above, the length of the body is sufficient so that when the proximal end is fastened to a mounting surface, the distal end is visible to a user, for example, in an overgrown field with weeds and grass. Accordingly, the present invention addresses the need for a marking stake that is lengthy enough to be visible. Also, as the body of the stake may be relatively flexible, the body may fold, tilt, or the like, and the stake is not susceptible to being dislodged from the ground, broken, bent, or moved in such a way as to destroy the lines, curves, grades, offsets, cuts, and fills that it represents.

Further, the stake can remain flat when it is not in use, overcoming the prior art problems of handling and transporting bulky stakes. In this manner, a series of stakes can lie in flat, lightweight stacks and be hand-carried readily in the field by a marking team.

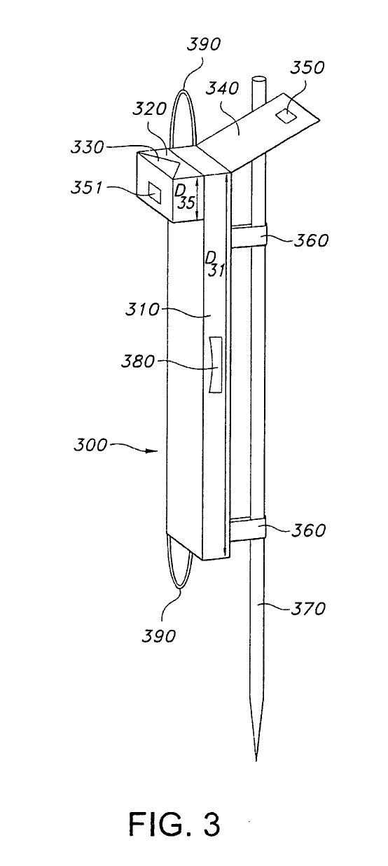

Turning to FIG. 3, a representative embodiment of a marking stake carrier 300 of the present invention is illustrated. The carrier includes a first portion 310, a second portion 320, and an adjustable fastener 360. Composition materials for various portions of the stake carrier include, but are not limited to, nylon, cotton, polyester, textile blends, rigid polymers, flexible polymers, composite materials, and the like. Also, methods of attachment for various parts of the carrier include, but are not limited to, integral formation, sewing, gluing, stapling, and the like.

The first portion 310 of the carrier is for carrying marking stakes, such as the marking stake 10 (from FIG. 1a). The first portion 310 has a volume and a length D₃₁, which both may vary. The length D₃₁ is sufficient to accommodate carrying substantially a full length of lengthy marking stakes. In certain embodiments, the length D₃₁ may be about 32 inches to accommodate marking stakes of about that length. In other embodiments, the length may be about 36 inches to accommodate marking stakes of about that length. In still other embodiments, the length may be about 12 inches to accommodate marking stakes of about that length. Those skilled in the art will appreciate that many other lengths are possible in other embodiments. Also, the first portion may take the form of any of a variety of shapes, including, but not limited to, cylindrical, cubical, rectangular, oblong, and the like.

The second portion 320 is for carrying marking stake fasteners and is connected to the first portion 310. The second portion has a volume, which may vary. The volume of the second portion is substantially less than the volume of the first portion. In certain embodiments, the volume of the second portion may be sufficient to accommodate about 50 magnetic nails. In other embodiments, the volume of the second portion may be sufficient to accommodate large spikes. Those skilled in the art will appreciate that many other volumes are possible in other embodiments. Also, the second portion may take the form of any of a variety of shapes, including, but not limited to, cylindrical, cubical, rectangular, oblong, and the like.

The second portion may have a length D₃₅. In certain embodiments, the length D₃₅ may be between about 6 and 8 inches. Those skilled in the art will appreciate that many other lengths are also possible in other embodiments. Also, in certain embodiments, some of the individual dimensions of the second portion may be greater than, equal to, or smaller than some of the individual dimensions of the first portion, even though the overall volume of the second portion is less than the overall volume of the first portion. For example, in certain embodiments, the width of the second portion may be equal to the width of the first portion. In other embodiments, the width of the second portion may be smaller than the width of the first portion. In still other embodiments, the width of the second portion may be greater than the width of the first portion.

The adjustable fastener 360 is provided to fasten the carrier to a surveying rod 370 with various diameters. The adjustable fastener may be connected to the first portion or the second portion and may take a variety of forms, such as Velcro® strips, adjustable buckles, buckles with adjustable straps, or the like.

In this manner, the first portion, second portion, and adjustable fastener form an all-in-one carrier 300 capable of simultaneously carrying the lengthy marking stakes and marking stake fasteners and of fastening to surveying rods with various diameters. As a result, the carrier addresses the need for a simple and organized method to handle and transport stakes and other marking equipment. Further, a series of stakes, such as the stake 10 (from FIG. 1a), can be placed in the carrier, as the stakes are adapted to lie in flat, lightweight stacks when not in use. In this manner, the carrier and stake of the present invention further address the need for a simple method to handle and transport stakes.

In certain embodiments, the carrier 300 may also include a third portion 330. The third portion 330 may be connected to any other part of the carrier. For example, in certain embodiments, the third portion 330 may be connected to the second portion 320. Also, in certain embodiments, the third portion may be a sub-portion of the second portion and share a common bottom and common walls on the exterior of the carrier with the second portion.

The third portion may have a volume substantially less than the volume of the second portion and may be used to carry writing utensils, such as a felt tip marker. In addition, the third portion may take the form of any of a variety of shapes, including, but not limited to, cylindrical, cubical, rectangular, oblong, and the like.

In certain embodiments, the carrier 300 may also include a lid 340 to close part or all of the carrier and to keep the elements out of part or all of the carrier. The lid may be connected to any other part of the carrier, including, but not limited to, the first portion, the second portion, and/or the third portion. Also, the lid may take the form of any of a variety of shapes, including, but not limited to, square, circular, oval, rectangular, oblong, and the like.

In addition, a fastening piece 350 may be fixed to the outer surface of the lid 340, and another fastening piece 351 may be fixed to another part of the carrier, such as the third portion 330. In this manner, the fastening pieces 350 and 351 secure the lid in the closed position. The fastening pieces 350 and 351 may take any of a variety of forms, such as, pieces of Velcro®, a hook and loop, a button and hole, snaps, clips, buckles, or the like.

In certain embodiments, the carrier 300 may also include a carrying handle 380 or a shoulder strap 390 to assist with transporting the carrier and its contents, during surveying, for example. The handle or shoulder strap may be connected to any other part of the carrier, including, but not limited to, the first portion, the second portion, and/or the third portion.

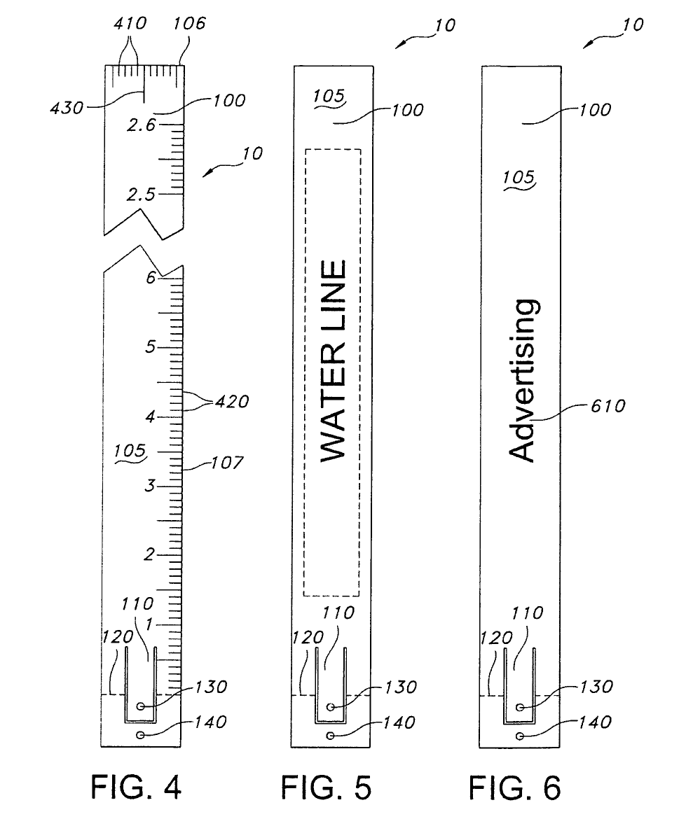

Turning to FIG. 4, in certain embodiments, the marking stake 10 may include graduations 410 on a surface 105. The graduations 410 may extend along the width of the body 100, such as along an edge 106 of the body. Also, the graduations 410 may be centered upon and extend outward on either side of a centerline 430 of the body 100. Among other purposes, the graduations 410 permit a survey instrument operator to find the centerline 430 when the centerline is hidden from the instrument operator's view because of the operator's line of vision with respect to the surface of the body. For example, by knowing that there are five equally spaced graduations on either side of the centerline, an operator can measure the precise amount of angular turn of the instrument between successively spaced graduations and thus estimate with a high degree of precision the precise position of the hidden centerline.

The graduations 410 also enhance the ability of a surveyor to survey extremely precise straight lines over long distances such as is often required in highway survey work by the well known procedure of double centering. As is known, the double centering procedure tends to reduce errors of alignment which always occur when extending a survey line from a back sight relative to a surveyor's instrument through a vertical arc to a forward sight position as the result of inherent inaccuracies or misalignment of the instrument itself. The graduations 410, extending laterally from the centerline 430, permit the instrument operator to more accurately split the difference in the instrument alignment observed to occur between successive back and forward sightings taken pursuant to the double centering procedure.

In addition, in certain embodiments, the marking stake 10 may include graduations 420 on the surface 105. The graduations 420 may extend along the length of the body 100, such as along an edge 107 of the body. The graduations shown in FIG. 4 are calibrated in tenths and hundredths of a foot as is usually preferred by engineers and surveyors in this country at the present time. However, those skilled in the art will appreciate that the particular calibrations of the graduations are a matter of choice depending in part upon the use and purpose to which the stake is to be applied. Accordingly, those skilled in the art will appreciate that many other calibrations of the graduations are possible. For example, in certain embodiments, the graduations may be calibrated in inches and tenths of inches.

As illustrated in FIG. 5, in certain embodiments, it is possible to print or write on the surface 105. The printing or writing may be substantially permanent. Also, printability and writability of the stake may be achieved in a variety of ways. In certain embodiments, the material of the stake is a printable and/or writable material, such as Correx®, cardboard, or the like. Additionally, in certain embodiments, the stake may be rough textured rather than smooth to further facilitate making marks thereon with ink, pencil, or other types of marking material.

Printing or writing on the stake can serve many functions. In certain embodiments, writing may be used to indicate a specific line being marked, such as a water line, as illustrated in FIG. 5. In other embodiments, writing may be used to mark the centerline 430 (from FIG. 4) in a suitable dark ink when the stake is used with a surveyor instrument for backsighting or for turning and ascertaining angles.

In yet other embodiments, desired grade levels on the scale of the graduations 420 (from FIG. 4) may be marked to indicate an amount of land fill or cut to be made at the point indicated by the stake. In this manner, a surveyor may readily simplify the calculation of cut or fill to be made by a contractor at or near the point marked by indicating with a suitable marking pen the precise level on the scale from which a vertical cut or fill is to be made. By selecting the precise and appropriate level on the scale, the surveyor can indicate to the contractor cuts or fills at each point marked in terms of whole numbers of feet rather than feet and fractional parts of feet. For example, suppose the stake is attached by a tack to a wood grade hub stake at a point a precise selected horizontal distance from where a cut is to be made in the earth. Suppose further that the precise vertical cut to be made between the top of the hub stake to the planned finished grade is 3.30 feet. The surveyor could mark the scale at 0.7 feet above the top of the hub, draw an arrow to the mark, and indicate behind the arrow “Cut-4.00”. At the same time, the surveyor can mark the top of the stake to indicate the precise horizontal offset distance between the hub and the line along which the desired cut is to be made.

As illustrated in FIG. 6, in certain embodiments, the stake 10 may include advertising 610 on the surface 105. In certain embodiments, the advertising may be printed directly on the material of the stake. In other embodiments, the advertising may be printed on a label that is affixed to the stake. Those skilled in the art will appreciate that other methods of including advertising are also possible in other embodiments.

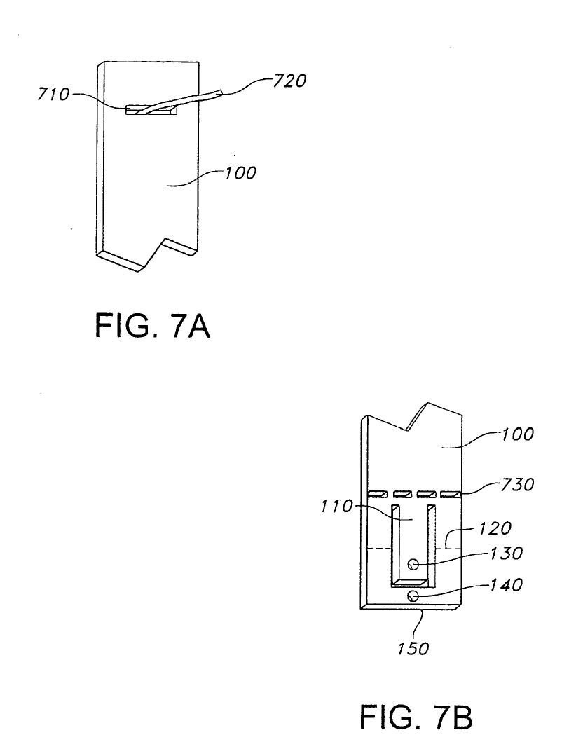

Turning to FIG. 7a, in certain embodiments, the stake 10 may include an aperture 710 near the distal end of the body. The aperture 710 may take any of a variety of forms, such as a circular hole, straight slit, sawtoothed slit, jagged hole, or the like. In certain embodiments, the aperture may be a jagged or sawtoothed slit so as to securely grip a cloth flag or plastic ribbon. In such embodiments, the teeth grip a flag or ribbon more firmly when the flag or ribbon is pulled, making it less likely that the same will be dislodged from the sawtooth slit by wind and weather than where the aperture is a simple, straight, transverse slit.

Accordingly, in certain embodiments, an indicator 720 may be extended through the aperture 710. The indicator 720 may be any of a variety of devices, such as a piece of string, a cloth flag, a plastic ribbon, or the like. For example, a cloth flag or plastic ribbon may be placed through the aperture to make the stake highly visible at a great distance. In another example, string may be placed through the apertures in several stakes to further assist in visualizing a marking area, such as a floor plan or a sewer or water line. In yet another example, both a piece of string and a cloth flag may be placed through the apertures in several stakes to further assist in marking an area.

The indicator 720 may also be any of a variety of colors, including, but not limited to, red, blue, green, yellow, orange, purple, and the like. Further, differently colored indicators may correspond to different uses. For example, blue indicators may be used to mark water lines in a survey area and orange indicators may be used to mark electrical lines in the same survey area. In this respect, different markings may be made in the same area.

In other embodiments, a carrying ring or other carrying device may be extended through the aperture 710 to facilitate carrying the stake. In this manner, several stakes may be easily carried at the same time.

As illustrated in FIG. 7b, in certain embodiments, the stake 10 may include a suitable transverse tear line 730 formed near the proximal end of the body 100. The tear line 730 permits a portion of the body near the distal end 160 to be torn away, as when the stake is struck by the treads or wheels of a vehicle, so that a remainder of the body near the proximal end 150, the tab 110, and the fastener 210, will not be dislodged from the mounting surface 220 to cause a loss of the desired point as marked. For example, a lawn mower blade may strike a portion of the body above the level of the tear line. In such cases, the blade will usually cause the portion of the body near the distal end to be torn away along the tear line before the fastener is dislodged from the ground, thus avoiding loss of the marked position. In this manner, the present invention further overcomes the problem of marking stakes susceptible to being dislodged from the ground, broken, bent, or moved in such a way as to destroy the lines, curves, grades, offsets, cuts, and fills that they represent. Also, the tear line 730 may be formed in any suitable and well known manner, such as by means of a series of aligned perforations, a weakened line, or the like.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. A marking stake, comprising:
a body substantially defining a plane, said body having a proximal end and a distal end, said body having a first aperture near said proximal end, and said body having a length sufficient so that when said proximal end is fastened to a mounting surface said distal end can be viewed by a user; and
a tab with said body, said tab having a second aperture, wherein said first aperture and said second aperture can register with one another during use by tilting said proximal end out of the plane containing a remainder of said body thereby tensioning said body in a substantially upright orientation during use.

2. The marking stake of claim 1, wherein said length comprises at least 32 inches.

3. The marking stake of claim 1, wherein said tab is defined by a cut in said body.

4. The marking stake of claim 1, wherein said stake is formed from Correx material.

5. The marking stake of claim 1, wherein said stake is substantially a uniform color.

6. The marking stake of claim 1, wherein a fastener is used to create said first aperture and said second aperture.

7. The marking stake of claim 1, further comprising graduations along a surface of said body.

8. The marking stake of claim 1, further comprising graduations extending along said length of said body.

9. The marking stake of claim 1, wherein a surface of said stake is capable of receiving a writing by a user during use so that said writing is substantially permanent.

10. The marking stake of claim 1, further comprising advertising on a surface of said stake.

11. The marking stake of claim 1, wherein said body further comprises a third aperture formed near said distal end.

12. The marking stake of claim 1, wherein said body further comprises a tear line formed near said proximal end.

13. A marking stake carrier, comprising:
a first portion for carrying lengthy marking stakes, said first portion having a first volume and a length, said length sufficient to accommodate carrying substantially a full length of said lengthy marking stakes;
a second portion for carrying marking stake fasteners, said second portion connected to said first portion and said second portion having a second volume, said second volume substantially less than said first volume; and
an adjustable fastener capable of fastening to surveying rods with various diameters, said fastener connected to said first portion or said second portion, wherein said first portion, said second portion, and said fastener form an all-in-one carrier capable of simultaneously carrying said lengthy marking stakes and said marking stake fasteners and capable of fastening to said surveying rods.

14. The marking stake carrier of claim 13, further comprising a third portion connected to said second portion, said third portion having a third volume, said third volume substantially less than said second volume.

15. The marking stake carrier of claim 13, further comprising a carrying handle connected to said first portion or said second portion.

16. The marking stake carrier of claim 13, further comprising a shoulder strap connected to said first portion or said second portion.

17. The marking stake carrier of claim 13, further comprising a lid to close said carrier and to keep the elements out of said carrier.

18. The marking stake carrier of claim 13, wherein said first portion and said second portion are substantially cylindrical.

19. A method for erecting a marking stake, comprising:
providing a marking stake with a body defining a plane, said body having a proximal end, a distal end, and a first aperture near said proximal end, and a tab with said body, said tab having a second aperture;
tilting said proximal end out of said plane containing a remainder of said body;
tensioning said body in a substantially upright orientation; and
driving a fastener through said first aperture and said second aperture.

20. The method of claim 19, wherein said tensioning further comprises registering said first aperture with said second aperture.
